(19) United States
(12) Patent Application Publication
(10) Pub. No.: US 2022/0017666 A1
(43) Pub. Date: Jan. 20, 2022

(54) Ethylene-Based Polymer Composition with Branching and Process for Producing the Same

(71) Applicant: Dow Global Technologies LLC, Midland, MI (US)

(72) Inventors: Hayley A. Brown, Lake Jackson, TX (US); Carmelo Declet Perez, Freeport, TX (US); John O. Osby, Lake Jackson, TX (US); Sean W. Ewart, Lake Jackson, TX (US); Sarat Munjal, Lake Jackson, TX (US); Christopher R. Eddy, Lake Jackson, TX (US); Mehmet Demirors, Pearland, TX (US); Jonathan D. Mendenhall, Lake Jackson, TX (US); Ivan A. Konstantinov, Lake Jackson, TX (US); Arkady L. Krasovskiy, Lake Jackson, TX (US)

(21) Appl. No.: 17/294,538

(22) PCT Filed: Nov. 26, 2019
(86) PCT No.: PCT/US2019/063406

§ 371 Date: May 17, 2021

Related U.S. Application Data
(60) Provisional application No. 62/774,002, filed on Nov. 30, 2018.

(51) Int. Cl. C08F 210/02; C08F 236/06; C08F 236/22; C08F 2/01; C08L 23/08

(52) U.S. Cl. CPC C08F 210/02; C08F 236/06; C08F 236/22; C08F 2/01; C08L 2207/07; C08L 2203/16; C08L 2203/202; C08L 2207/066; C08L 23/083

(57) ABSTRACT

The present disclosure provides a polymer composition. In an embodiment, an ethylene-based polymer composition is provided and is formed by high pressure (greater than or equal to 100 MPa), free-radical polymerization, by reacting: ethylene monomer and a mixture of hydrocarbon-based molecules, with each hydrocarbon-based molecule comprising three or more terminal alkene groups.

### BACKGROUND

The level of branching in a low density polyethylene (LDPE) is due predominantly to the reactor design and the polymerization conditions used to make the LDPE. Branching agents have been used to increase the level of branching in an LDPE. However, the process conditions required to achieve a modified LDPE with a high level of branching, often result in a final product with a lower crystallinity, and with a higher content of a low molecular weight extractable fraction. Thus, there is a need for a modified LDPE that has high branching levels, and that can be prepared under conditions that maintain good polymer properties.

### SUMMARY

The present disclosure provides a polymer composition. In an embodiment, an ethylene-based polymer composition is provided and is formed from high pressure (greater than or equal to 100 MPa), free-radical polymerization, by reacting: ethylene monomer and a mixture of hydrocarbon-based molecules, with each hydrocarbon-based molecule comprising three or more terminal alkene groups.

The present disclosure provides a process. In an embodiment, the process includes reacting, in a polymerization reactor under free-radical polymerization conditions and at a pressure greater than or equal to 100 MPa, ethylene monomer and a mixture of hydrocarbon-based molecules. Each hydrocarbon-based molecule includes three or more terminal alkene groups. The process includes forming an ethylene-based polymer composition. In a further embodiment, each the hydrocarbon-based molecules has the Structure I:

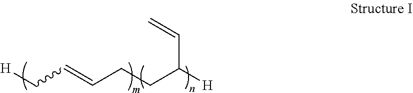

wherein n is from 3 to 160, and m is from 0 to 50.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure.

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

Unless stated to the contrary, implicit from the context, or customary in the art, all parts and percents are based on weight, and all test methods are current as of the filing date of this application.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “ethylene/alpha-olefin copolymer,” as used herein, refers to a copolymer that has more than 50 mole percent polymerized ethylene monomer (based on the total amount of polymerizable monomers), and at least one alpha-olefin.

The term “ethylene monomer,” as used herein, refers to a chemical unit having two carbon atoms with a double bond there between, and each carbon bonded to two hydrogen atoms, wherein the chemical unit polymerizes with other such chemical units to form an ethylene-based polymer composition.

The term “high density polyethylene,” (or HDPE) as used herein, refers to an ethylene-based polymer having a density of at least 0.94 g/cc, or from at least 0.94 g/cc to 0.98 g/cc. The HDPE has a melt index from 0.1 g/10 min to 25 g/10 min. The HDPE can include ethylene and one or more C₃-C₂₀ α-olefin comonomers. The comonomer(s) can be linear or branched. Nonlimiting examples of suitable comonomers include propylene, 1-butene, 1 pentene, 4-methyl-1-pentene, 1-hexene, and 1-octene. The HDPE can be prepared with either Ziegler-Natta, chromium-based, constrained geometry or metallocene catalysts in slurry reactors, gas phase reactors or solution reactors. The ethylene/C₃-C₂₀ α-olefin copolymer includes at least 50 percent by weight ethylene polymerized therein, or at least 70 percent by weight, or at least 80 percent by weight, or at least 85 percent by weight, or at least 90 weight percent, or at least 95 percent by weight ethylene in polymerized form.

The term “hydrocarbon-based molecule,” as used herein, refers to a chemical component that has only carbon atoms and hydrogen atoms.

The term “linear low density polyethylene,” (or “LLDPE”) as used herein, refers to a linear ethylene/α-olefin copolymer containing heterogeneous short-chain branching distribution comprising units derived from ethylene and units derived from at least one C₃-C₁₀ α-olefin, or C₄-C₈ α-olefin comonomer. LLDPE is characterized by little, if any, long chain branching, in contrast to conventional LDPE. LLDPE has a density from 0.910 g/cc to less than 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips)

The term “low density polyethylene,” (or LDPE) as used herein, refers to a polyethylene having a density from 0.909 g/cc to less than 0.940 g/cc, or from 0.917 g/cc to 0.930 g/cc, and long chain branches with a broad molecular weight distribution (MWD greater than 3.0).

The term “terminal alkene group,” as used herein, refers to a double bond between two carbon atoms in a polymer chain, wherein one of the carbons in the double-bond is a ═CH₂ group. Terminal double bonds are located at terminal ends of polymer chains and/or at branched ends of polymer chains. The term “internal alkene group,” as used herein, refers to a 1,2-disubstituted carbon-carbon double bond, the carbon atoms are in a trans-configuration (not cis-configuration). An internal alkene group is located throughout the length of a polymer chain, but not at a terminal end of the polymer chain or at a branched end along a polymer chain. Terminal alkene groups and internal alkene groups are measured by infrared spectroscopy (“IR”).

The term “alkene content,” as used herein, refers to the number of terminal alkene groups plus the number of internal alkene groups, present in a polymer chain for every 1000 carbon atoms. Alkene content is measured by infrared spectroscopy (“IR”).

### Test Methods

Density is measured in accordance with ASTM D792, Method B. Results are reported in grams per cubic centimeter (g/cc).

The term “GI200,” as used herein, refers to the gel index including all gels at least 200 microns in diameter. The degree of crosslinking of the ethylene-based polymer composition is measured by dissolving the composition in a solvent for a specified duration, and calculating the percent gel or unextractable component. The percent gel normally increases with increasing crosslinking levels. GI200 results are reported in mm²/24.6 cm³. G′ Value

The term “G′ value,” as used herein, refers to the storage modulus of a material. Storage modulus is a measure of stored energy, or elastic response, of a material. The term “loss modulus,” (or G″) as used herein, is a measure of dissipated energy of a material in response to stress. The sample used in the G′ measurement is prepared from a compression molding plaque. A piece of aluminum foil is placed on a back plate, and a template or mold is placed on top of the back plate. Next, 12 grams of resin is placed in the mold, and a second piece of aluminum foil is placed over the resin and mold. A second back plate is then placed on top of the aluminum foil. The total ensemble is put into a compression molding press run at the following conditions: 3 min at 150° C. and 100 MPa, followed by 1 min at 150° C. and 150 MPa, followed by a “1.5 min” quench cooling to room temperature at 150 MPa. A 25 mm disk is stamped out of the compression-molded plaque. The thickness of the disk is 2.0 mm. The rheology measurement to determine G′ is done in a nitrogen environment at 170° C. and a strain of 10%. The stamped-out disk is placed between the two “25 mm” parallel plates located in an ARES-1 (Rheometrics SC) rheometer oven, which is preheated for at least 30 minutes at 170° C., and the gap of the “25 mm” parallel plates is slowly reduced to 1.65 mm. The sample is then allowed to remain for exactly 5 minutes at these conditions. The oven is then opened, the excess sample is carefully trimmed around the edge of the plates, and the oven is closed. The storage modulus (G′) and loss modulus (G″) of the sample are measured via a small amplitude, oscillatory shear according to a decreasing frequency sweep form 100 to 0.1 rad/s (when able to obtain a G″ value lower than 500 Pa at 0.1 rad/s), or from 100 to 0.01 rad/s. For each frequency sweep, 1-points (logarithmically spaced) per frequency decade are used. The data are plotted (G′ (Y-axis) versus G″ (X-axis)) on a log-log scale. The Y-axis scale covers the range from 10 to 1000 Pa, while the X-axis scale covers the range from 100 to 1000 Pa. The Orchestrator software is used to select the data in the region where G″ is between 200 and 800 Pa (or using at least 4 data points). The data are fit to a log polynomial model using the fit equation Y=C1+C2 In(x). Using the Orchestrator software, G′ at G″ equal to 500 Pa is determined by interpolation. G′ and G″ are reported in Pascals (Pa).

### Hexane Extractables

The term “hexane extractables,” as used herein, refers to the amount of hexane soluble material cleansed out of the resultant polymer composition by hexane. Polymer pellets (from the polymerization without further modification; 2.2 grams per press) are pressed to form a film, with a Carver Press, at a thickness from 3.0 to 4.0 mils. Pellets are pressed in two phases. The melt phase is at 190° C. for 3 minutes at 3000 pounds. The compressing phase is at 190° C. for 3 minutes at 40000 pounds. Non-residue gloves (PIP* CleanTeam* Cotton Lisle Inspection Gloves, Part Number: 97-501) are worn so as to not contaminate films with residual oils from hands of the operator. Films are die cut into “1 inch×1 inch” squares, and weighed (2.5±0.05 g). The films are then extracted for two hours in a hexane vessel at “49.5±0.5° C.” in a heated water bath. After two hours, the films are removed, rinsed in clean hexane, and dried in a vacuum oven (80±5° C.) at full vacuum (ISOTEMP Vacuum Oven, Model 281A, at 30 inches Hg) for two hours. The films are then placed in a desiccator, and allowed to cool to room temperature for a minimum of one hour. The films are then reweighed, and the amount of mass loss due to extraction in hexane is calculated. This method is based on 21 CFR § 177.1520 (d)(3)(ii) with one deviation from FDA protocol by using hexane instead of n-hexane. Hexane extractable is reported in wt %.

### Melt Elasticity

The term “melt elasticity,” as used herein, refers to the ability of a polymer to bend, or become mobile from a static state upon melting. Melt elasticity is measured using a D-MELT apparatus (available from Goettfert GmbH Buchen, Germany). The DMELT apparatus includes a commercial plastometer, and a digital balance incorporating a custom weighted sample. Samples for density measurement are prepared according to ASTM D1928. Samples are pressed at 190° C. and 30,000 psi for 3 minutes, and then at (21° C.) and 207 MPa for 1 minute. Measurements are made within one hour of sample pressing using ASTM D792, Method B. For the melt elasticity measurement, a molten polymer strand is extruded from a standard plastometer (MP600 Extrusion Plastometer (Melt Indexer) System Installation & Operation Manual (#020011560), Tinius Olsen, 1065 Easton Road, Horsham, Pa. 19044-8009) barrel at a constant temperature (190° C.) through a standard ASTM D1238 MFR die (orifice height (8.000±0.025 mm) and diameter (2.0955±0.005 mm)) using a weighted piston. The extrudate is pulled through a series of free spinning rollers onto a roller driven by a stepper motor (Stepper Motor and Controller Operating Manual, Oriental Motor USA Corporation, 2570 W. 237^{th} Street, Torrance, Calif. 90505) which is ramped over a velocity range during the analysis. The force of the polymer strand pulling up on the balance (Excellence Plus XP Precision Balance Operating Instructions, Mettler Toledo, 1900 Polaris Parkway, Columbus, Ohio 43240) platform mounted tension roller is recorded by the integrated control computer. From a linear regression of the acquired force data, the final reported value is determined based on a constant velocity ratio (33.2) or strain (Ln[Speed ratio]=3.5) of the polymer strand speed versus the die exit speed. Melt elasticity is reported in units of centiNewtons (cN).

### Melt Index

The term “melt index,” as used herein, refers to the measure of how easily a thermoplastic polymer flows when in a melted state. Melt index, or I₂, is measured in accordance by ASTM D 1238, Condition 190° C./2.16 kg, and is reported in grams eluted per 10 minutes (g/10 min). The 110 is measured in accordance with ASTM D 1238, Condition 190° C./10 kg, and is reported in grams eluted per 10 minutes (g/10 min).

### Melt Strength

The term “melt strength,” as used herein, refers to the measure of the maximum tension applied to a polymer in a melted state, before the polymer breaks. Melt strength is measured at 190° C. using a Göettfert Rheotens 71.97 (Göettfert Inc.; Rock Hill, S.C.). The melted sample (from 25 to 50 grams) is fed with a Göettfert Rheotester 2000 capillary rheometer, equipped with a flat entrance angle (180 degrees), and of length of 30 mm and diameter of 2 mm. The sample is fed into the barrel (L=300 mm, Diameter=12 mm), compressed, and allowed to melt for 10 minutes, before being extruded at a constant piston speed of 0.265 mm/s, which corresponds to a wall shear rate of 38.2 s⁻¹ at the given die diameter. The extrudate passes through the wheels of the Rheotens, located at 100 mm below the die exit, and is pulled by the wheels downward, at an acceleration rate of 2.4 millimeters per square second (mm/s²). The force (measured in centiNewtons, cN) exerted on the wheels is recorded as a function of the velocity of the wheels (in mm/s). Samples are repeated at least twice, until two curves of the force (in cN) as a function of strand velocity (in mm/s) superimpose, then the curve that had the highest velocity at the strand break is reported. Melt strength is reported as the plateau force before the strand breaks, in units of cN.

### Nuclear Magnetic Resonance (¹H NMR)

The term “nuclear magnetic resonance,” (or NMR) as used herein, refers to a spectral analysis of a material or compound that shows the elemental and structural composition of the material or compound. Samples for proton NMR were prepared using 0.1-0.2 g sample in 2.75 g of 30/70 wt/wt o-dichlorobenzene-d4/perchloroethylene (ODCB-d4/PCE) containing 0.001 M Cr, prepared in a 10 mm tube. The samples were heated and vortexed at 115° C. to ensure homogeneity. Single pulse proton spectra were acquired on a Bruker AVANCE 400 MHz spectrometer equipped with a Bruker Dual DUL high-temperature CryoProbe and a sample temperature of 120° C. PBD spectra were acquired with ZG pulse P1=5 us (^{˜}30° PW), 16 scans, AQ 1.64 s, D₁ 14 s. LDPE-PBD samples were run using ZG pulse with 90° PW, 32 scans, AQ 1.64 s, D₁ 14 s.

### Gas Chromatography Analysis

The term “gas chromatography analysis,” as used herein, refers to a method of separating components of a chemical compound by weight.

### Water Extraction and Preparation for Headspace—Solid Phase Microextraction (HS-SPME)

Each film was prepared, as described in the Experimental section, under “Extrusion Coating.” Two grams (about 1 in by 1 in) of each sample (approx. 1.3 mil polymer coated onto release liner and removed to serve as a free standing film) were weighed into individual “20 mL” headspace vials, and the vials were sealed. Vials with films were equilibrated at 75° C. for 10 minutes, and the headspace was extracted by SPME for analysis by gas chromatography with a quadrupole mass spectrometer (GC/qMS).

### Preparation for HS-SPME

Ten grams of each film (approximately 1 in×1 in) were weighed into “40 mL” glass bottles (I-Chem, high purity). The vials were completely filled with high purity water (ASTM Type I, Reagent grade, Mill-Q Integral 3, 18.2 MΩ, <5 ppb TOC). The vials were sealed with PTFE lined caps and the film was extracted for 48 h at 40° C. After 48 hours, the bottles were removed from the oven and the contents were allowed to return to room temperature (approximately 4 h). HS-SPME analysis was performed using 20 mL headspace vials. Each vial was prepared with “3.5 g” of sodium sulfate (Sigma-Aldrich, ACS Reagent grade, purified by heating in a furnace at 1050° F. for 12 hours) and 10 grams of water extract (no film). The mixture was vigorously mixed and sonicated for 15 min to dissolve the sodium sulfate. The vials were then equilibrated at 75° C. for 10 min, and the headspace was extracted by SPME for analysis by gas chromatography with a quadrupole mass spectrometer (GC/qMS).

### GC/ODP/qMS Analysis Conditions

The headspace in each vial was sampled by SPME and analyzed by GC/qMS. Quantitation was performed using an external standard calibration procedure. Automated sample analysis was performed using a Gerstel Multipurpose Sampler (MPS), an Agilent 7890A gas chromatography, and an Agilent 5975C inert XL quadrupole mass spectrometer. The MPS was controlled using Gerstel's Maestro software. Control and data collection of the GC/qMS was performed using Agilent's Chemstation software. The headspace of the water extracts was sampled using a “2 cm×50/30 μm” di-alkene benzene/carboxen/polydimethylsiloxane (Supleco) SPME fiber with equilibration of the water at 75° C., with agitation for 10 minutes. The components on the SPME fiber were desorbed in split/splitless inlet at 250° C., followed by separation using an Agilent, VF-WAXms, “30 m×250 μm×0.5 μm” capillary column, with an oven temperature program of 50° C. (2 minute hold) to 260° C. (6 minute hold), at 15° C./min, and an initial column flow of 2.0 mL/min of helium.

Samples were then comparatively ranked on a scale of 1-5 (with 1 indicating the least and 5 indicating the most) of the detected oxygenated species (OS) or the total volatile organic compounds (VOC) in the material.

### Gel Permeation Chromatography (GPC)

The chromatographic system consisted of a PolymerChar GPC-IR (Valencia, Spain) high temperature GPC chromatograph equipped with an internal IRS infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 160° Celsius and the column compartment was set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with at least 20 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1)

where M is the molecular weight, A has a value of 0.4315 and B is equal to 1.0.

A polynomial between 3^{rd} and 5^{th} order was used to fit the respective polyethylene-equivalent calibration points. A small adjustment to A (from approximately 0.375 to 0.440) was made to correct for column resolution and band-broadening effects such that a homopolymer polyethylene standard with a molecular weight of 120,000.

The total plate count of the GPC column set was performed with Eicosane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{{RV}_{Peak Max}}{Peak Width at \frac{1}{2} height} )}^{2} \qquad ( EQ 2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( EQ 3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 24,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$$\begin{matrix}{Mn}_{( GPC )} = \frac{{\sum }^{i} {IR}_{i}}{{\sum }^{i} ( {IR}_{i} / {M}_{{polyethylene}_{i}} )} & ( EQ 4 ) \\ {Mw}_{( GPC )} = \frac{{\sum }^{i} ( {IR}_{i} * {M}_{{polyethylene}_{i}} )}{{\sum }^{i} {IR}_{i}} & ( EQ 5 ) \\ {Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} & ( EQ 6 )\end{matrix}$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−2% of the nominal flowrate.

Flowrate(effective)=Flowrate(nominal)*(RV(FM Calibrated)/RV(FM Sample)) (EQ7)

### Triple Detector GPC (TDGPC)

The chromatographic system, run conditions, column set, column calibration and calculation conventional molecular weight moments and the distribution were performed according to the method described in Gel Permeation Chromatography (GPC).

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn>3) to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, N.Y. (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, do/dc, of 0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (MW_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™) Other respective moments, Mn_{(Abs)} and Mz_{(Abs)} are be calculated according to equations 8-9 as follows:

$$\begin{matrix}{Mn}_{( Abs )} = \frac{{\sum }^{i} {IR}_{i}}{{\sum }^{i} ( {IR}_{i} / {M}_{{Absolute}_{i}} )} & ( EQ 8 ) \\ {Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} & ( EQ 9 )\end{matrix}$$

gpcBR Branching Index by Triple Detector GPC (3D-GPC)

The gpcBR branching index is determined by first calibrating the light scattering, viscosity, and concentration detectors as described previously. Baselines are then subtracted from the light scattering, viscometer, and concentration chromatograms. Integration windows are then set to ensure integration of all of the low molecular weight retention volume range in the light scattering and viscometer chromatograms that indicate the presence of detectable polymer from the infrared (IR5) chromatogram. Linear polyethylene standards are then used to establish polyethylene and polystyrene Mark-Houwink constants. Upon obtaining the constants, the two values are used to construct two linear reference conventional calibrations for polyethylene molecular weight and polyethylene intrinsic viscosity as a function of elution volume, as shown in Equations (10) and (11):

M_{PE}=(K_{PS}/K_{PE})^{1/α}^{_{PE}}⁺¹·M_{PS}^{α}^{_{PS}}^{+1/α}^{_{PE}}⁺¹ (Eq. 10)

[η]PE=K_{PS}·M_{PS}^{α+1}/M_{PE} (Eq. 11).

The gpcBR branching index is a robust method for the characterization of long chain branching as described in Yau, Wallace W., “Examples of Using 3D-GPC-TREF for Polyolefin Characterization,” Macromol. Symp., 2007, 257, 29-45. The index avoids the “slice-by-slice” 3D-GPC calculations traditionally used in the determination of g′ values and branching frequency calculations, in favor of whole polymer detector areas. From 3D-GPC data, one can obtain the sample bulk absolute weight average molecular weight (Mw, Abs) by the light scattering (LS) detector, using the peak area method. The method avoids the “slice-by-slice” ratio of light scattering detector signal over the concentration detector signal, as required in a traditional g′ determination.

With 3D-GPC, sample intrinsic viscosities are also obtained independently using Equations (8). The area calculation in Equation (5) and (8) offers more precision, because, as an overall sample area, it is much less sensitive to variation caused by detector noise and 3D-GPC settings on baseline and integration limits. More importantly, the peak area calculation is not affected by the detector volume offsets. Similarly, the high-precision sample intrinsic viscosity (IV) is obtained by the area method shown in Equation (12):

$${IV}_{w} = \frac{{\sum }_{i} {c}_{i} {IV}_{i}}{{\sum }_{i} {c}_{i}} = \frac{{\sum }_{i} {η}_{{sp}_{i}}}{{\sum }_{i} {c}_{i}} = \frac{Viscometer Area}{Conc . Area} \qquad ( Eq . 12 )$$

where ηₛₚᵢ stands for the specific viscosity as acquired from the viscometer detector.

To determine the gpcBR branching index, the light scattering elution area for the sample polymer is used to determine the molecular weight of the sample. The viscosity detector elution area for the sample polymer is used to determine the intrinsic viscosity (IV or [η]) of the sample.

Initially, the molecular weight and intrinsic viscosity for a linear polyethylene standard sample, such as SRM1475a or an equivalent, are determined using the conventional calibrations (“cc”) for both molecular weight and intrinsic viscosity as a function of elution volume, per Equations (2) and (13):

$${[ η ]}_{cc} = \frac{{\sum }_{i} {c}_{i} {IV}_{i , cc}}{{\sum }_{i} {c}_{i}} = \frac{{\sum }_{i} {c}_{i} {K ( {M}_{i , cc} )}^{a}}{{\sum }_{i} {c}_{i}} \qquad ( Eq . 13 )$$

Equation (14) is used to determine the gpcBR branching index:

$$gpcBR = [ ( \frac{{[ η ]}_{cc}}{[ η ]} ) {( \frac{{M}_{w}}{{M}_{w , cc}} )}^{{α}_{PE}} - 1 ] \qquad ( Eq . 14 )$$

wherein [η] is the measured intrinsic viscosity, [η]_{cc} is the intrinsic viscosity from the conventional calibration, Mw is the measured weight average molecular weight, and Mw_{,cc} is the weight average molecular weight of the conventional calibration. The weight average molecular weight by light scattering (LS) using Equation (5) is commonly referred to as “absolute weight average molecular weight” or “Mw, Abs.” The Mw,cc using conventional GPC molecular weight calibration curve (“conventional calibration”) is often referred to as “polymer chain backbone molecular weight,” “conventional weight average molecular weight,” and “Mw_{,GPC}.”

All statistical values with the “cc” subscript are determined using their respective elution volumes, the corresponding conventional calibration as previously described, and the concentration (Ci). The non-subscripted values are measured values based on the mass detector, LALLS, and viscometer areas. The value of K_{PE} is adjusted iteratively, until the linear reference sample has a gpcBR measured value of zero. For example, the final values for a and Log K for the determination of gpcBR in this particular case are 0.725 and −3.391, respectively, for polyethylene, and 0.722 and −3.993, respectively, for polystyrene. These polyethylene coefficients were then entered into Equation 13.

Once the K and α values have been determined using the procedure discussed previously, the procedure is repeated using the branched samples. The branched samples are analyzed using the final Mark-Houwink constants obtained from the linear reference as the best “cc” calibration values.

The interpretation of gpcBR is straight forward. For linear polymers, gpcBR calculated from Equation (14) will be close to zero, since the values measured by LS and viscometry will be close to the conventional calibration standard. For branched polymers, gpcBR will be higher than zero, especially with high levels of long chain branching, because the measured polymer molecular weight will be higher than the calculated Mw,cc, and the calculated IVcc will be higher than the measured polymer IV. In fact, the gpcBR value represents the fractional IV change due the molecular size contraction effect as the result of polymer branching. A gpcBR value of 0.5 or 2.0 would mean a molecular size contraction effect of IV at the level of 50% and 200%, respectively, versus a linear polymer molecule of equivalent weight.

For these particular examples, the advantage of using gpcBR, in comparison to a traditional “g′ index” and branching frequency calculations, is due to the higher precision of gpcBR. All of the parameters used in the gpcBR index determination are obtained with good precision, and are not detrimentally affected by the low 3D-GPC detector response at high molecular weight from the concentration detector. Errors in detector volume alignment also do not affect the precision of the gpcBR index determination. Fourier Transform Infrared analysis

Determination of the amount of terminal (vinyl) and internal (or trans-) double bonds per 1000 carbons is by Fourier Transform Infrared analysis (“FTIR”). Sample films (approximately 250-300 microns in thickness) used for FTIR analysis were compression molded by pressing approximately 0.5 g of pellets of the sample in a Carver hydraulic press with heated platens set to 190° C. The level of terminal alkenes and internal alkenes were measured following a procedure similar to the one outlined in ASTM method D6248.

### DETAILED DESCRIPTION

The present disclosure provides an ethylene-based polymer composition. The ethylene-based polymer composition includes the polymerization product of ethylene monomer and a mixture of hydrocarbon-based molecules having three or more terminal alkene groups.

In an embodiment, the ethylene-based polymer composition is formed from a process involving high pressure (greater than 100 MPa) and free-radical polymerization. Ethylene monomer and a mixture of hydrocarbon-based molecules having three or more terminal alkene groups are reacted together to form the ethylene-based polymer composition. The polymerization process is discussed in detail below.

Hydrocarbon-Based Molecule

The ethylene-based polymer composition is the polymerization reaction product of ethylene and the mixture of hydrocarbon-based molecules having three or more terminal alkene groups. The hydrocarbon-based molecules have only carbon atoms and hydrogen atoms, and have three or more terminal alkene groups. The term “hydrocarbon-based molecules comprising three or more terminal alkene groups,” (or interchangeably referred to as “hydrocarbon-based molecules”) as used herein, refers to a chemical component that is a polymer chain composed of only carbon atoms and hydrogen atoms, the polymer chain being branched and having three or more terminal ends wherein an alkene group (i.e. carbon-carbon double) bond is present at each terminal end. The term “mixture of hydrocarbon-based molecules,” as used herein, refers to two or more hydrocarbon-based molecules, wherein at least two of the molecules differ in structure, property, and/or composition.

In an embodiment, the number of terminal alkene groups present in each of the hydrocarbon-based molecules is from 3, or 5, or 7, or 8 to 17, or 18. In a further embodiment, the number of terminal alkene groups present in each of the hydrocarbon-based molecules is from 3 to 40, or from 5 to 40, or from 10 to 40, or from 12 to 20. By way of example, the mixture of hydrocarbon-based molecules may include a first hydrocarbon-based molecule having three terminal alkene groups and a second hydrocarbon-based molecule having twelve terminal alkene groups.

In an embodiment, each of the hydrocarbon-based molecules in the mixture has the Structure I:

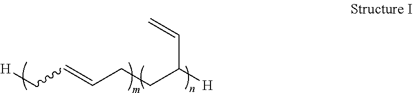

wherein n (the number of terminal alkene groups) from 3 to 160, and m (the number of internal alkene groups) is from 0 to 50. In another embodiment, n is from 3, or 5, or 10, or 20, or 30, or 40, and m is from 0, or 10, or 20, or 40, or 50. In a further embodiment, n is from 3 to 160, or from 5 to 100, or from 9 to 40, and m is from 0 to 30, or from 1 to 20, or from 2 to 10.

In an embodiment, mixture of hydrocarbon-based molecules consist of two or more hydrocarbon-based molecules having Structure I:

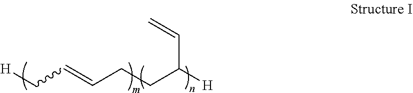

wherein n is the number of terminal alkene groups, m is the number of internal alkene groups, and the average n content in the mixture of hydrocarbon-based molecules is from 9 to 40, and the average m content is from 1 to 10. The “average n content” is calculated by dividing the number average molecular weight (Mn) by the weight average molecular weight (Mw) of the hydrocarbon-based molecule, then multiplying by the fractional amount of terminal alkene groups. The “average m content” is calculated by dividing the number average molecular weight (Mn) by the weight average molecular weight (Mw) of the hydrocarbon-based molecule, then multiplying by the fractional amount of internal alkene groups.

In an embodiment, mixture of hydrocarbon-based molecules has respective average n content and average m content (denoted as “n/m”, see Structure I for each hydrocarbon-based molecule) as follows: 9-40/1-10, or 12-38/2-8, or 13-37/2-6, or 15-35/2-6, or 19/3, or 33/5.

In an embodiment, the mixture of hydrocarbon-based molecules based on Structure I has a molecular weight distribution from 1.2 to 20. In another embodiment, the mixture of hydrocarbon-based molecules based on Structure I has a molecular weight distribution from 1.2, or 1.3, or 1.4 to 2, or 5 to 10 or 20. In a further embodiment, the mixture of hydrocarbon-based molecules based on Structure I has a molecular weight distribution from 1.2 to 20, or from 1.3 to 10, or from 1.5 to 5.

In an embodiment, each of the hydrocarbon-based molecules has the Structure II:

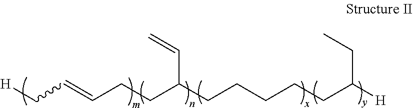

wherein n is from 3 to 160, and m is from 0 to 50; x is from 0 to 160, and y is from 0 to 50. In another embodiment, n is from 3, or 5, or 10, or 20, or 30, or 40, or 50 to 60, or 70 to 80, or 90, or 100, or 110, or 120, or 130, or 140, or 150, or 160, and m is from 0, or 10, or 20 to 30, or 40, or 50; x is from 0, or 1, or 5, or 10, or 20, or 30, or 40, or 50 to 60, or 70 to 80, or 90, or 100, or 110, or 120, or 130, or 140, or 150, or 160, and y is from 0, or 1, or 10, or 20 to 30, or 40, or 50. In a further embodiment, n is from 3 to 160, or from 5 to 150, or from 9 to 140, or from 9 to 100, or from 9 to 50, or from 9 to 30, m is from 0 to 30, or from 1 to 20, or from 1 to 10, x is from 0 to 160, or from 1 to 50, or from 1 to 20, or from 1 to 10, and y is from 0 to 50, or from 1 to 20, or from 1 to 10.

The hydrocarbon-based molecules of Structure I and/or Structure II are hereafter interchangeably referred to as “branching agent.”

The notation “ [symbol] ” in Structure I and in Structure II represents a cis alkyl group or a trans alkyl group with respect to the double bond.

In an embodiment a mixture of hydrocarbon-based molecules having the Structure I and/or the Structure II, with differing molecular weights, is used.

It is understood that the present ethylene-based polymer composition may include (i) Structure I only, (ii) Structure II only, or (iii) a combination of Structure I and Structure II. It is understood that the term “ethylene-based polymer composition,” as used herein, refers to the polymer that is the reaction product of ethylene with Structure I and/or Structure II.

In an embodiment, the ethylene-based polymer composition includes, in polymerized form, from 95 wt %, or 96 wt %, or 97 wt %, or 98 wt % to 99 wt %, or 99.5 wt %, or 99.7 wt %, or 99.9 wt % of ethylene, and a reciprocal amount of the mixture of hydrocarbon-based molecules, or from 5.0 wt %, or 4.0 wt %, or 3.0 wt %, or 2.0 wt % to 1.0 wt %, or 0.5 wt %, or 0.3 wt %, or 0.1 wt % of the mixture of the hydrocarbon-based molecules. Weight percent is based on total weight of the ethylene-based polymer composition. In a further embodiment, the ethylene-based polymer composition includes, in polymerized form, from 95.0 wt % to 99.9 wt %, or from 96 wt % to 99.8 wt %, or from 98 wt % to 99.8 wt % of ethylene, and the mixture of hydrocarbon-based molecules is present in an amount from 5.0 wt % to 0.1 wt %, or from 4.0 wt % to 0.2 wt %, or from 2.0 wt % to 0.2 wt %.

The ethylene-based polymer composition has a density from 0.909 g/cc to 0.940 g/cc. In an embodiment, the ethylene-based polymer composition has a density from 0.909 g/cc, or 0.915 g/cc, or 0.920 g/cc to 0.930 g/cc, or 0.935 g/cc, or 0.940 g/cc. In another embodiment, the ethylene-based polymer composition has a density from 0.910 g/cc to 0.940 g/cc, or from 0.915 g/cc to 0.935 g/cc, or from 0.917 g/cc to 0.930 g/cc, or from 0.917 g/cc to 0.926 g/cc.

In an embodiment, the ethylene-based polymer composition has a melt index (I₂) from 0.10 g/10 min to 200 g/10 min. In another embodiment, the ethylene-based polymer composition has a melt index from 0.1 g/10 min, or 1.0 g/10 min, or 5.0 g/10 min, or 10 g/10 min, or 20 g/10 min, or 30 g/10 min, or 40 g/10 min, to 50 g/10 min, or 60 g/10 min, 70 g/10 min, or 75 g/10 min, or 80 g/10 min, or 90 g/10 min, or 100 g/10 min. In a further embodiment, the ethylene-based polymer composition has a melt index from 0.1 g/10 min to 200 g/10 min, or from 0.1 g/10 min to 100 g/10 min, or from 0.1 g/10 min to 80 g/10 min, or from 0.1 g/10 min to 20 g/10 min.

In an embodiment, the ethylene-based polymer composition has a melt index (I₂) from 0.1 g/10 min to 8.0 g/10 min.

In an embodiment, the ethylene-based polymer composition has an alkenes content from 0.05/1000 carbons, or 0.15/1000 carbons, or 0.3/1000 carbons, or 0.4/1000 carbons, to 1.0/1000 carbons, or 2.0/1000 carbons, or 3.0/1000 carbons. In an embodiment, the ethylene-based polymer composition has an alkenes content from 0.05/1000 carbons to 3.0/1000 carbons, or from 0.05/1000 carbons to 1/1000 carbons, or from 0.08/1000 carbons to 1/1000 carbons.

In an embodiment, the ethylene-based polymer composition has a melt elasticity from 0.1 cN to 100 cN, and a melt index from 0.1 g/10 min to 100 g/10 min.

In an embodiment, the ethylene-based polymer composition has a G′ value greater than or equal to C+D log(I₂), wherein C is 185 Pa and D is −90 Pa/log(g/10 min), wherein I₂ is the melt index of the ethylene-based polymer composition, Pa is Pascals (N/m²), and log(g/10 min) is the logarithm of the melt index of the ethylene-based polymer composition.

In an embodiment, the ethylene-based polymer composition has a GI200 value from 0 mm²/24.6 cm³ to 20 mm²/24.6 cm³. In an embodiment, the ethylene-based polymer composition has a GI200 value from 0 mm²/24.6 cm³, or 0.05 mm²/24.6 cm³, or 0.3 mm²/24.6 cm³, to 0.7 mm²/24.6 cm³, 5 mm²/24.6 cm³, or 20 mm²/24.6 cm³. In a further embodiment, the ethylene-based polymer composition has a GI200 value from 0 mm²/24.6 cm³ to 20 mm²/24.6 cm³, or from 0.05 mm²/24.6 cm³ to 5 mm²/24.6 cm³, or from, 0.3 mm²/24.6 cm³ to 0.7 mm²/24.6 cm³.

In an embodiment, the ethylene-based polymer composition has a density from 0.900 g/cc to 0.940 g/cc, and a melt index from 0.1 g/10 min to 200 g/10 min. In another embodiment, the ethylene-based polymer composition has a density from 0.900 g/cc, or 0.910 g/cc, or 0.920 g/cc to 0.925 g/cc, or 0.930 g/cc, and a melt index from 0.1 g/10 min, or 2.0 g/10 min, or 3.0 g/10 min to 9.0 g/10 min, or 10 g/10 min, or 100 g/10 min. In a further embodiment, the ethylene-based polymer composition has a density from 0.900 g/cc to 0.940 g/cc, or from 0.910 g/cc to 0.930 g/cc, or from 0.917 g/cc to 0.925 g/cc, and a melt index from 0.1 g/10 min to 200 g/10 min, or from 0.1 g/10 min to 100 g/10 min, or from 0.1 g/10 min to 20.0 g/10 min.

In an embodiment, the ethylene-based polymer composition has one, some, or all of the following properties:

(i) an alkenes content from 0.05/1000 carbons, or 0.15/1000 carbons, or 0.3/1000 carbons, or 0.4/1000 carbons, to 1.0/1000 carbons, or 2.0/1000 carbons, or 3.0/1000 carbons; and/or

(ii) a melt elasticity from 0.1 cN to 100 cN, and a melt index from 0.1 g/10 min to 200 g/10 min; and/or

(iii) a G′ value greater than or equal to C+D log(I₂), wherein C is 185 Pa and D is −90 Pa/log(g/10 min); and/or

(iv) a GI200 value from 0.05 mm²/24.6 cm³ to 20 mm²/24.6 cm³; and/or

(v) a density from 0.909 g/cc to 0.940 g/cc.

In an embodiment, the ethylene-based polymer composition has a Mw(abs) versus I₂ relationship, with Mw(abs) less than or equal to A+B(I₂), wherein A is 2.65×10⁵ g/mol and B is −8.00×10⁻³ (g/mol)/(dg/min) (hereafter Equation A) and the ethylene-based polymer composition has a G′ versus I₂ relationship, wherein G′ is greater than or equal to N C+D log(I₂), where C is 185 Pa and D is −90 Pa/log(g/10 min) (hereafter Equation B). In other words, the present ethylene-based polymer has a Mw(abs) value less than the value from Equation A and G′ value greater than the value from Equation B.

In an embodiment, the ethylene-based polymer composition is a low density polyethylene (LDPE) that includes, in polymerized form, ethylene monomer and the mixture of hydrocarbon-based molecules.

The present ethylene-based polymer composition is produced via in-reactor high pressure polymerization. Bound by no particular theory, it is believed that copolymerization of ethylene monomer and the mixture of hydrocarbon-based molecules may occur by multiple scenarios. Two possible scenarios are (i) reaction of propagating polymer chain (PC) with terminal alkene group of the hydrocarbon-based molecules followed by further propagation and termination, and (ii) reaction of propagating polymer chain (PC) with internal alkene group of the hydrocarbon-based molecules followed up by further propagation and termination.

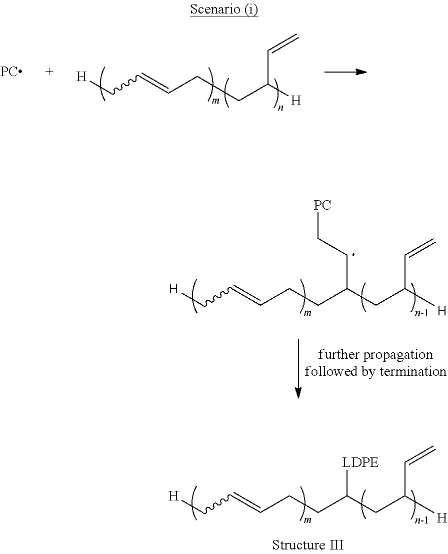

The resultant ethylene-based polymer composition (Structure III) has polyethylene chain (LDPE) bonded directly to a hydrocarbon-based molecule. Single terminal alkene group or multiple terminal alkene groups can be attacked by propagating polymer chain (PC) leading to single or multiple LDPEs been attached to the hydrocarbon-based molecule. In an embodiment, two or more terminal alkene groups undergo copolymerization, while the remaining terminal alkene groups remain unreacted.

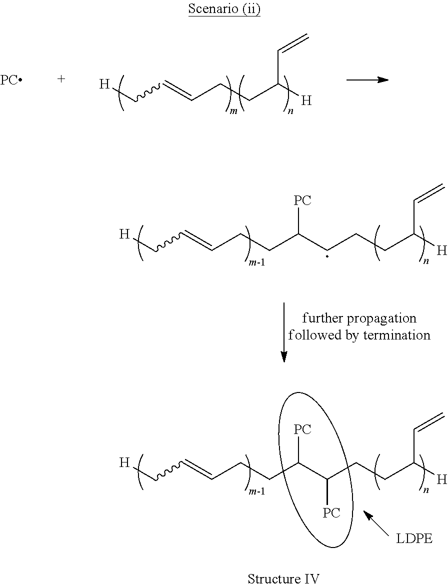

The resultant ethylene-based polymer composition (Structure IV) has two polyethylene chains bonded to a hydrocarbon-based molecule at the internal alkene group reaction point (in the “m” section of a hydrocarbon-based molecule) that combine to form an LDPE unit. Single internal alkene group or multiple internal alkene groups can be attacked by propagating polymer chain (PC) leading to single or multiple LDPEs that are copolymerized with the hydrocarbon-based molecule. In an embodiment, two or more internal alkene groups undergo reaction, while the remaining internal alkene groups remain unreacted. A single internal and/or terminal alkene group or multiple internal and/or external alkene groups can be attacked by propagating polymer chain (PC) leading to single or multiple LDPEs that are copolymerized with the hydrocarbon-based molecule. In an embodiment, two or more alkene groups undergo reaction, while the remaining internal alkene groups remain unreacted.

Final product of the in-reactor reaction of the growing polymer chain at the terminal alkene group (scenario I above) followed by further propagation and termination differs from post-reactor terminal alkene group grafting. Post-reactor terminal alkene group grafting is shown below:

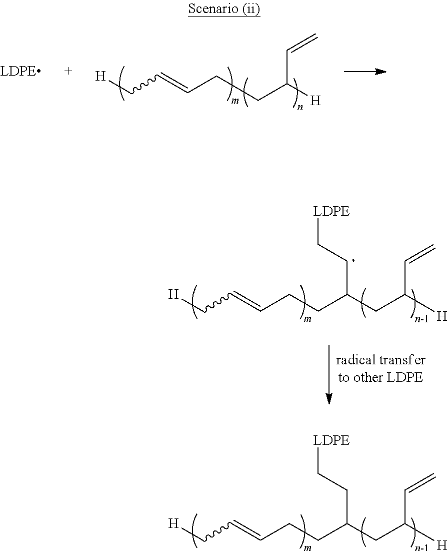

In post-reactor terminal alkene group grafting, LDPE is bonded to a hydrocarbon-based molecule at the terminal alkene group reaction point. A separate molecule, normally another LDPE, reacts with the intermediate product to form the resultant ethylene-based polymer composition.

Final product of the in-reactor reaction of the growing polymer chain at the internal alkene group followed by further propagation and termination (scenario ii above) differs from post-reactor internal alkene grafting. Post-reactor internal alkene grafting is shown below:

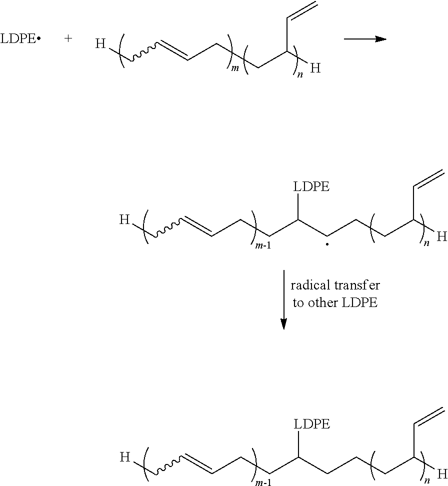

In post-reactor internal alkene grafting reaction, LDPE is bonded to a hydrocarbon-based molecule at the internal alkene group reaction point. A separate molecule, typically another LDPE, reacts with the intermediate product to form the resultant ethylene-based polymer composition.

In an embodiment, the ethylene-based polymer composition has Structure III and/or Structure IV as discussed above, and has one, some, or all of the following properties:

(i) an alkenes content from 0.05/1000 carbons, or 0.15/1000 carbons, or 0.3/1000 carbons, or 0.4/1000 carbons to 1.0/1000 carbons, or 2.0/1000 carbons, or 3.0/1000 carbons; and/or

(ii) a melt elasticity from 0.1 cN to 100 cN, and a melt index from 0.1 g/10 min to 200 g/10 min; and/or

(iii) a G′ value greater than or equal to C+D log(I₂), where C is 185 Pa and D is −90 Pa/log(g/10 min); and/or

(iv) a GI200 value from 0 mm²/24.6 cm³ to 20 mm²/24.6 cm³; and/or

(v) a density from 0.909 g/cc to 0.940 g/cc, and a melt index from 0.1 g/10 min to 200 g/10 min.

In an embodiment, the ethylene-based polymer composition has a hexane extractable from 1.0 wt % to 5.0 wt %, based on the weight of the ethylene-based polymer composition. In another embodiment, the ethylene-based polymer composition has a hexane extractable from 1.0 wt %, or 1.1 wt %, or 1.5 wt % to 2.6 wt %, or 3.5 wt %, or 5.0 wt %. In a further embodiment, the ethylene-based polymer composition has a hexane extractable from 1.0 wt % to 4.5 wt %, or from 1.1 wt % to 3.5 wt %, or from 1.5 wt % to 2.6 wt %.

In an embodiment, the ethylene-based polymer composition includes a blend component. The blend component is a polymer that does not include the mixture of the hydrocarbon-based molecules.

In an embodiment, the blend component is an ethylene-based polymer that does not include the mixture of the hydrocarbon based molecules. Nonlimiting examples of suitable ethylene-based polymers include ethylene/alpha-olefin copolymer, ethylene/C₃-C₈ alpha-olefin copolymer, ethylene/C₄-C₈ alpha-olefin copolymer, and copolymers of ethylene and one or more of the following comonomers: acrylate, (meth)acrylic acid, (meth)acrylic ester, carbon monoxide, maleic anhydride, vinyl acetate, vinyl propionate, mono esters of maleic acid, diesters of maleic acid, vinyl trialkoxysilane, vinyl trialkyl silane, and any combination thereof.

In an embodiment, the blend component is an ethylene-based polymer having a density from 0.890 g/cc, or 0.900 g/cc, or 0.905 g/cc, or 0.910 g/cc, or 0.915 g/cc, or 0.917 g/cc to 0.925 g/cc, or 0.930 g/cc, or 0.935 g/cc, or 0.940 g/cc, or 1.05 g/cc. In a further embodiment, the ethylene-based polymer that is the blend component has a density from 0.900 g/cc to 0.940 g/cc, or from 0.905 g/cc to 0.935 g/cc, or from 0.910 g/cc to 0.930 g/cc, or from 0.915 g/cc to 0.925 g/cc, or from 0.917 g/cc to 0.925 g/cc.

In an embodiment, the blend component has a melt index (I₂) from 0.1 to 200 g/10 min.

In an embodiment, the blend component is a high density polyethylene (HDPE).

In an embodiment, the blend component is linear low density polyethylene (LLDPE).

In an embodiment, the blend component is a low density polyethylene (LDPE).

In another embodiment, the blend component is an ethylene/alpha-olefin copolymer. In a further embodiment, the alpha-olefin of the blend component is a C₃-C₈ alpha-olefin, or a C₄-C₈ alpha-olefin.

The present disclosure also provides an article comprising at least one component formed from the composition of an embodiment, or a combination of two or more embodiments, described herein.

In an embodiment, the article is a coating of a film.

In an embodiment, the article is a coating.

In an embodiment, the article is a film.

The ethylene-based polymer composition includes a combination of two or more embodiments as described herein.

The article includes a combination of two or more embodiments as described herein.

The present disclosure also provides a process of producing the present ethylene-based polymer composition. The process includes reacting, in a polymerization reactor under free-radical polymerization conditions and at a pressure greater than 100 MPa, ethylene monomer in the presence of the mixture of hydrocarbon-based molecules that have three or more terminal alkene groups. The process includes forming the present ethylene-based polymer composition.

In an embodiment, the polymerization takes place in a reactor configuration comprising at least one tubular reactor or at least one autoclave reactor.

In an embodiment, the polymerization takes place in a reactor configuration that includes at least one tubular reactor.

In an embodiment, the polymerization takes place in a reactor configuration that includes at least one autoclave reactor.

In an embodiment, the ethylene monomer is polymerized in the presence of at least 2 mole ppm (based on amount of total monomers in reaction feed) of the additive of the mixture of hydrocarbon-based molecules.

In an embodiment, the polymerization pressure is greater than, or equal to, 100 MPa.

In another embodiment, the polymerization takes place with at least one polymerization pressure from 100 MPa to 360 MPa.

In a further embodiment, the polymerization takes place with at least one temperature from 100° C. to 380° C.

In order to produce a highly branched ethylene-based polymer composition, a high pressure, free-radical initiated polymerization process is used. Two different high pressure free-radical initiated polymerization process types are known. In the first process type, an agitated autoclave reactor having one or more reaction zones is used. The autoclave reactor normally has several injection points for initiator or monomer feeds, or both. In the second process type, a jacketed tube is used as a reactor, which has one or more reaction zones. Suitable, but not limiting, reactor lengths may be from 100 meters to 3000 meters (m), or from 1000 meters to 2000 meters. The beginning of a reaction zone, for either type of reactor, is typically defined by the side injection of either initiator of the reaction, ethylene, chain transfer agent (or telomer), comonomer(s), as well as any combination thereof. A high pressure process can be carried out in autoclave reactors or tubular reactors having one or more reaction zones, or in a combination of autoclave reactors and tubular reactors, each comprising one or more reaction zones.

In an embodiment, an initiator is injected prior to the reaction zone where free radical polymerization is to be induced.

In an embodiment, a conventional chain transfer agent (CTA) is used to control molecular weight.

In another embodiment, one or more conventional CTAs are added to an inventive polymerization process. Non-limiting examples of CTAs include propylene, isobutane, n-butane, 1-butene, methyl ethyl ketone, acetone, ethyl acetate, propionaldehyde, ISOPAR (ExxonMobil Chemical Co.), and isopropanol. In an embodiment, the amount of CTA used in the process is from 0.01 weight percent to 10 weight percent of the total reaction mixture.

In an embodiment, the process includes a process recycle loop to improve conversion efficiency.

In an embodiment, the polymerization takes place in a tubular reactor, such as described in international patent application PCT/US12/059469 (WO2013059042(A1), filed Oct. 10, 2012. This patent application describes a multi zone reactor which describes alternate locations of feeding fresh ethylene to control the ethylene to CTA ratio and therefore control polymer properties. Fresh ethylene monomer is simultaneously added in multiple locations to achieve the desired ethylene monomer to chain transfer ratio as described in international patent application PCT/US12/064284 (filed Nov. 9, 2012) (WO2013078018(A2). In a similar way addition of fresh CTA addition points is carefully selected to control polymer properties. Fresh CTA is simultaneously added in multiple locations to achieve the desired CTA to ethylene monomer ratio. Likewise, the addition points and the amount of fresh branching agents, described in this application, are controlled to control gel formation while maximizing the desired property of increased melt strength and performance in targeted applications. Fresh branching agent is simultaneously added in multiple locations to achieve the desired branching agent to ethylene monomer ratio. The use of a branching agent and/or coupling agent to broaden molecular weight distribution and to increase the melt strength of the polymer will put further requirements on the distribution of the CTA and the branching agent along a reactor system in order to achieve the desired change in product properties without or minimizing potential negative impacts such as gel formation, reactor fouling, process instabilities, and minimizing the amount of branching agent.

In an embodiment, the polymerization takes place in at least one tubular reactor. In a multi reactor system, the autoclave reactor precedes the tubular reactor. The addition points and amounts of fresh ethylene, fresh CTA, and fresh branching agent are controlled to achieve the desired ratios of CTA to ethylene monomer and branching agent to ethylene monomer in the feeds to and or in the reaction zones.

In an embodiment, the branching agent is fed through a compression stage directly into the reaction zone or directly into the feed to the reaction zone. The choice of feed point into the reaction and/or a reaction zone depends on several factors, including, but not limited to, the solubility of the polyene in pressurized ethylene and/or solvent, the condensation of the polyene in pressurized ethylene, and/or fouling by premature polymerization of the branching agent in the pre-heater used to heat the reactor contents prior to injection of initiator.

In an embodiment, the branching agent is fed directly into the reaction zone or directly into the feed to the reaction zone.

In an embodiment, branching agent is added prior to, or simultaneously with, the addition of the free-radical initiator, at the inlet of the reaction zone. In another embodiment, the branching agent is added prior to the initiator addition to allow for a good dispersion of the polyene.

In an embodiment, the branching agent is fed only to reaction zone 1.

In an embodiment, more branching agent, by mass, is added to reaction zone 1 as compared to the amount of polyene, by mass, added to a subsequent reaction zone.

In an embodiment, the ethylene fed to the first reaction zone is from 10 percent to 100 percent of the total ethylene fed to the polymerization. In a further embodiment, the ethylene fed to the first reaction zone is from 20 percent to 80 percent, further from 25 percent to 75 percent, further from 30 percent to 70 percent, further from 40 percent to 60 percent, of the total ethylene fed to the polymerization.

In an embodiment, the process takes place in a reactor configuration that comprises at least one tubular reactor. In a further embodiment, the maximum temperature in each reaction zone is from 150° C. to 360° C., further from 170° C. to 350° C., further from 200° C. to 340° C.

In an embodiment, the polymerization pressure at the first inlet of the reactor is from 100 MPa to 360 MPa, further from 150 MPa to 340 MPa, further from 185 MPa to 320 MPa.

In an embodiment, the ratio of “the concentration of the CTA in the feed to reaction zone i” to “the concentration of the CTA in the feed added to reaction zone 1” is greater than, or equal to, 1.

In an embodiment, the ratio of “the concentration of the CTA in the feed to reaction zone i” to “the concentration of the CTA in the feed added to reaction zone 1” is less than 1, further less than 0.8, further less than 0.6, further less than 0.4.

In an embodiment the number of reaction zones range from 3 to 6.

Non-limiting examples of ethylene monomer used for the production of the ethylene-based polymer composition include purified ethylene, which is obtained by removing polar components from a loop recycle stream, or by using a reaction system configuration, such that only fresh ethylene is used for making the inventive polymer. Further examples of ethylene monomer include ethylene monomer from a recycle loop.

In an embodiment, the ethylene-based polymer composition includes ethylene monomer, the mixture of hydrocarbon-based molecules (Structure I or Structure II), and one or more comonomers, and preferably one comonomer. Non-limiting examples of suitable comonomers include α-olefins, acrylates, carbon monoxide, methacrylates, (meth)acrylic acid, monoesters of maleic acid, diesters of maleic acid, anhydrides, vinyl acetate, vinyl propionate, vinyl trialkoxysilanes, vinyl trialkyl silanes each having no more than 20 carbon atoms. The α-olefin comonomers have from 3 to 10 carbon atoms, or in the alternative, the α-olefin comonomers have from 4 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene.

In an embodiment, the ethylene-based polymer composition includes ethylene monomer and at least one hydrocarbon-based molecules (Structure I or Structure II) as the only monomeric units.

Free Radical Initiators

In an embodiment, free radical initiators are used to produce the inventive ethylene-based polymer compositions. Non-limiting examples of organic peroxides cyclic peroxides, diacyl peroxides, dialkyl peroxides, hydroperoxides, peroxycarbonates, peroxydicarbonates, peroxyesters, peroxyketals, t-butyl peroxy pivalate, di-t-butyl peroxide, t-butyl peroxy acetate and t-butyl peroxy-2-hexanoate, and combinations thereof. In an embodiment, these organic peroxy initiators are used in an amount from 0.001 wt % to 0.2 wt %, based upon the weight of polymerizable monomers.

In an embodiment, an initiator is added to at least one reaction zone of the polymerization, and wherein the initiator has a “half-life temperature at one second” greater than 255° C., or greater than 260° C.

In another embodiment, such initiators are used at a peak polymerization temperature from 320° C. to 350° C.

In a further embodiment, the initiator includes at least one peroxide group incorporated in a ring structure. Non-limiting examples of initiators include TRIGONOX 301 (3,6,9-triethyl-3,6,9-trimethyl-1,4,7-triperoxonaan) and TRIGONOX 311 (3,3,5,7,7-pentamethyl-1,2,4-trioxepane), both available from Akzo Nobel, and HMCH-4-AL (3,3,6,6,9,9-hexamethyl-1,2,4,5-tetroxonane) available from United Initiators.

In an embodiment, the configuration of the tubular reactor includes three to five reaction zones, with fresh ethylene fed to the front of the tubular reactor, and recycled ethylene fed to the side of the tubular reactor. Fresh CTA is fed to the side of the tubular reactor. The mixture of hydrocarbon-based molecules is fed to the front of the tubular reactor, with direct feed of the mixture of hydrocarbon-based molecules after preheating of the tubular reactor.

Additives

In an embodiment, the composition includes one or more additives. Non-limiting examples of additives include stabilizers, plasticizers, antistatic agents, pigments, dyes, nucleating agents, fillers, slip agents, fire retardants, processing aids, smoke inhibitors, viscosity control agents and anti-blocking agents. The polymer composition may, for example, comprise less than 10 percent of the combined weight of one or more additives, based on the weight of the ethylene-based polymer composition.

In an embodiment the ethylene-based polymer composition is treated with one or more stabilizers, for example, antioxidants, such as IRGANOX 1010, IRGANOX 1076 and IRGAFOS 168. In general, the ethylene-based polymer composition is treated with one or more stabilizers before extrusion or other melt processes.

In an embodiment, the ethylene-based polymer composition further includes at least one other polymer, in addition to the inventive ethylene-based polymer with the mixture of hydrocarbon-based molecules (Structure I or Structure II). Blends and mixtures of the ethylene-based polymer composition with other polymers may be prepared. Suitable polymers for blending with the inventive polymers include natural and synthetic polymers. Exemplary polymers for blending include propylene-based polymers, ethylene/alkene alcohol copolymers, polystyrene, impact modified polystyrene, ABS, styrene/butadiene block copolymers and hydrogenated derivatives thereof (SBS and SEBS), and thermoplastic polyurethanes.

Other ethylene-based polymer compositions for blending with the present ethylene-based polymer composition include homogeneous polymers, such as olefin plastomers and elastomers (for example, polymers available under the trade designations AFFINITY Plastomers and ENGAGE Elastomers (The Dow Chemical Company) and EXACT (ExxonMobil Chemical Co.), Propylene-based copolymers (for example, polymers available under the trade designation VERSIFY Plastomers & Elastomers (The Dow Chemical Company) and VISTAMAXX (ExxonMobil Chemical Co.) can also be useful as components in blends comprising an inventive polymer.

Applications

The ethylene-based polymer composition of the present disclosure may be employed in a variety of conventional thermoplastic fabrication processes to produce useful articles, including but not limited to monolayer and multilayer films; molded articles, such as blow molded, injection molded, or rotomolded articles; coatings; fibers; and woven or non-woven fabrics, cables, pipes, green house films, silo bag films, collation Shrink films, food packaging films, foams.

The ethylene-based polymer composition may be used in a variety of films, including but not limited to, clarity shrink films, collation shrink films, cast stretch films, silage films, stretch hood, sealants, and diaper backsheets. Other suitable applications include, but are not limited to, wires and cables, gaskets and profiles, adhesives; footwear components, and auto interior parts.

Applicant unexpectedly discovered that a mixture of hydrocarbon-based molecules that has either Structure I or Structure II used in-reactor, with n is greater than three (or n greater than 5), resulted in an ethylene-based polymer composition having an increased number of branching points, which results in a greater change in melt rheology. The higher branch levels, as seen in the GPC and melt rheology data and improved solubility of the ethylene-based polymer composition, results in reduced reactor fouling and reduced gel formation of the ethylene-based polymer composition. The resultant ethylene-based polymer composition also has improved (reduced) taste and odor performance, as compared to some other polymer compositions modified with other types of branching agents including for example PPG-AEMA.

### Examples

Commercially Available Reagents

LDPE 5004i, PG7004, PT7007, and PT7009 each is LDPE ethylene homopolymer produced in an autoclave reactor. Each is available from The Dow Chemical Company. Isopar E, Isopar H, and Isopar L are available from Exxon Chemicals.

Polybutadiene (Additive A: Nisso PB B-1000, Additive B: Nisso PB B-2000) were supplied from Nippon Soda, Co. Properties for these materials are listed in Table 1 below.

TABLE 1

| | | | % terminal | % internal | Avg n | Avg m |
|---|---|---|---|---|---|---|
| | Mn (g/mol)¹ | Mw/Mn² | alkene¹ | alkene¹ | content³ | content³ |
| Additive A | 1200 | 1.47 | 85 | 15 | 19 | 3 |
| Additive B | 2100 | 1.56 | 88 | 12 | 33 | 5 |

¹Provided by Nippon Soda
²Determined by GPC
³Calculated by dividing Mn by Mw of butadiene monomer (hydrocarbon-based molecule) and multiplying by fractional amount of terminal alkene groups for n, and internal alkene groups for m. Example: Mn = 1200 g/mol, Avg n = (1200 g/mol)/(54.09 g/mol butadiene monomer) = 22 repeat units*0.85 (terminal /total alkene) = 18.8 terminal vinyl groups per chain on average

1. Polymerization I: Autoclave Reactor

Preparation of Solutions

Asymmetrical Diene Comparative Sample I: Isoprenyl Methacrylate (IPMA), shown below

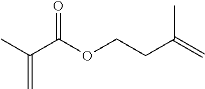

Comparative branching agent 1

was loaded into a 316 stainless steel supply vessel, and diluted with ethyl acetate, to produce a final concentration of 7.8 wt %. This vessel was purged with nitrogen for three hours before use and kept under 70 psig nitrogen pad.

### Inventive Example I

Additive A was loaded into a 316 stainless steel supply vessel, and diluted with Isopar™ E to produce a final concentration of 1.7 wt %. This vessel was purged with nitrogen for three hours before use and kept under 70 psig nitrogen pad during operation.

Various feed levels of this solution were introduced into the reactor to produce polymer samples. Additive B was added to the reactor in the same manner as Additive A.

Initiators: Peroxide initiator tert-butyl peroxyacetate (TPA, 20% by weight solution in ISOPAR™ H), and peroxide initiator di-tert-butyl peroxide (DTBP, 20% by weight solution in ISOPAR™ H), were combined with ISOPAR E, in a second 316 stainless steel supply vessel, to produce 1500 mass ppm TPA and 415 mass ppm DTBP (a ratio of 4:1 mole TPA/mole DTBP). The vessel was padded, de-padded, five times with 70 prig nitrogen before use, and kept under nitrogen pad during operation.

Ethylene was injected at 5500 gm/hr, at a pressure of 193 MPa, into an agitated (1600 rpm) 300 mL high pressure CSTR reactor, with an external heating jacket set to control the internal reactor temperature at 220° C. Propylene (CTA) was added to the ethylene stream at a pressure of 6.2 MPa, and controlled at a rate to produce a final product with a MI of ^{˜}4 g/10 min, before the mixture was compressed to 193 MPa, and injected into the reactor. The solution of the appropriate additive solution was pumped at a pressure of 193 MPa directly into the reactor via a high pressure pump. The peroxide initiator solution was added directly to the reactor, through the sidewall, at a pressure of 193 MPa at a rate to control the ethylene conversion near 12%.

The details of the polymerization procedure for each experiment are shown in Table 2 below.

TABLE 2
Autoclave Polymerization Conditions (at ethylene feed 5,500 g/hr and at 220° C.)

| | | t-butyl | | | | | |
|---|---|---|---|---|---|---|---|
| | | peroxy- | di-t-butyl | IPMA | Additive | Ethylene | Polymer |
| | Propylene | acetate | peroxide | feed | A feed | Conversion | Collected |
| Experiment | (g/hr) | (g/hr) | (g/hr) | (g/hr) | (g/hr) | (%) | (g/hr) |
| Control | 120 | 0.38 | 0.08 | 0 | 0 | 12.1 | 660 |
| Comparative | 232 | 0.18 | 0.04 | 2.79 | 0 | 11.6 | 640 |
| Sample I | | | | | | | |
| Inventive | 135 | 0.15 | 0.03 | 0 | 2.72 | 13.0 | 700 |
| Example I | | | | | | | |

Properties of ethylene homopolymer produced in the autoclave reactor are provided in Table 3 below.

TABLE 3
Ethylene Homopolymer Properties

| | MI (I₂) | I₁₀ | MS | |
|---|---|---|---|---|
| Example | (g/10 min) | (g/10 min) | (cN, 190° C.) | MI* MS |
| Control | 4.3 | 47.4 | 12.4 | 53.3 |
| Comparative | 6.7 | 70.4 | 13.0 | 87.1 |
| Sample I | | | | |
| Inventive | 5.1 | 55.0 | 14.6 | 74.5 |
| Example I | | | | |

2. Melt Strength Experimentation

Additional samples were made under the autoclave polymerization conditions of Polymerization I, disclosed above. In particular, both Additive A and Additive B feed rates were varied while holding melt index (MI) constant (at or near 4 g/10 min). Applicant discovered that while holding melt index constant, increasing the amount of either Additive A or Additive B increased the melt strength of the polymer. The results of the melt strength experimentation are shown in Table 4 below.

TABLE 4
Melt Strength Experimentation Results

| | Amount fed | MI (I₂) | ME | MS |
|---|---|---|---|---|
| Additive | (mol ppm) | (g/10 min) | (cN, 190° C.) | (cN, 190° C.) |
| None | 0 | 3.7 | 3.6 | 5.8 |
| None | 0 | 5.2 | 3.6 | 5.4 |
| None | 0 | 5.6 | 3.5 | 4.9 |
| Additive A | 2 | 3.5 | 4.9 | 7.8 |
| Additive A | 2 | 3.6 | 5.0 | 7.8 |
| Additive A | 2 | 4.2 | 5.0 | 7.2 |
| Additive A | 4 | 4.2 | 5.3 | 7.9 |
| Additive A | 4 | 4.7 | 5.2 | 7.3 |
| Additive A | 4 | 4.4 | 6.0 | 8.4 |
| Additive A | 6 | 4.8 | 5.8 | 7.9 |
| Additive A | 6 | 3.7 | 7.1 | 8.4 |
| Additive A | 6 | 3.0 | 7.5 | 10.2 |
| Additive A | 6 | 3.7 | 5.8 | 6.6 |
| Additive A | 6 | 3.0 | 6.9 | 8.0 |
| Additive A | 6 | 3.5 | 4.5 | 6.4 |
| Additive A | 8 | 3.5 | 4.8 | 6.7 |
| Additive A | 8 | 3.6 | 4.4 | 6.3 |
| Additive A | 8 | 4.0 | 4.1 | 3.1 |
| Additive A | 10 | 4.6 | 4.3 | 6.5 |
| Additive A | 10 | 3.9 | 4.6 | 6.5 |
| None | 0 | 3.8 | 3.1 | 5.1 |
| None | 0 | 4.9 | 2.1 | 3.9 |
| None | 0 | 4.6 | 2.6 | 4.4 |
| Additive B | 4 | 4.7 | 3.0 | 5.9 |
| Additive B | 4 | 5.5 | 2.7 | 4.9 |
| Additive B | 7 | 4.6 | 4.2 | 6.3 |
| Additive B | 7 | 4.5 | 4.2 | 6.4 |
| Additive B | 7 | 3.6 | 5.1 | 8.8 |

3. Extrusion Coating

Each of the polymer compositions, Control, Comparative Sample I, and Inventive Example I, is subjected to extrusion coating, temperature, and shear to determine thermal stability and breakdown product. All coating experiments were performed on a Black-Clawson Extrusion Coating Line. The extruder was equipped with a 3.5 inch, 30:1 LID, 4:1 compression ratio single flight screw with two spiral Mattock mixing sections. The nominal die width of 91 cm (36 inches) was deckled (metal dam to block the flow in the die at the die exit around the outer edges of the die, and used to decrease the die width, and thus decrease the polymer flow out of the die) to an open die width of 61 cm (24 inches). In extrusion coating, a deckle is a die insert that sets the coating width of a slot die coater or the extrusion width of an extrusion die. It works by constraining the flow as the material exits the die.

For the extrusion coating evaluation, a constant 15.2 cm (6 inches) air gap was set for all resins. The die gap was set to 20 mil, however small adjustments were needed to maintain a constant coating thickness. The temperatures in each zone of the extruder were 177, 232, 288, and 316° C. (die) (350, 450, 550 and 600° F. (die)), respectively, leading to a target melt temperature of 318° C. (605° F.). The screw speed was 90 rpm, resulting in 250 lb/hr output rate. Line speed was at 440 ft/min (fpm) resulting in a 1.3 mil coating onto a 50 lb/ream KRAFT paper (the width of the KRAFT paper was 61 cm (24 inches); unbleached). A free standing piece of polymer film for analytical testing (e.g., HS-SPME) was obtained by coating the resin onto a release liner. A piece of silicon coated release liner 61 cm (24 inches) wide was inserted between the polymer coating and the paper substrate before the molten polymer curtain touched the paper substrate to form a “polymer coating/release liner/KRAFT paper” configuration in which the paper and release liner are not adhered to each other. The “polymer coating/release liner” sub-configuration was rolled and wrapped in food grade aluminum foil. The solidified polymer coatings were detached from the release liner for analytical testing.

The amount of neck-in (the difference in actual coating width versus deckle width (61 cm)) was measured at line speeds of 440 feet per min and 880 feet per minute (fpm), resulting in a “1.3 mil” and a “0.65 mil” coating thickness, respectively. Amperage and Horse Power of the extruder were recorded. The amount of backpressure was also recorded for each polymer without changing the back pressure valve position. Draw down is the line speed at which edge imperfections on the polymer coating (typically the width of the polymer coating oscillating along the edges of the polymer coating) were noticed, or the line speed at which the molten curtain completely tears from the die. A reduced rate draw down (RRDD) was measured for all resins at 45 rpm screw speed by ramping up the line speed until edge imperfections or web tear was noticed. Extrusion coating results are shown in Table 5 below.

TABLE 5
Extrusion coating results

| | 440 NI¹ | 880 NI² | RRDD³ | HP⁴ | AMPS⁵ | PRESS⁶ |
|---|---|---|---|---|---|---|
| Control | 2.75 | 2.5 | 925 | 26 | 130 | 1142 |
| Comparative | 2 | Nd⁷ | 625 | 23 | 120 | 999 |
| Sample I | | | | | | |
| Inventive | 2.125 | 2 | 800 | 25 | 125 | 1134 |
| Example I | | | | | | |

¹ Neck-in at line speed of 440 fpm and screw speed of 90 rpm
² Neck-in at line speed of 880 fpm and screw speed of 90 rpm
³ Reduced rate draw down at screw speed of 45 rpm
⁴ Horse power
⁵ Amperage
⁶ Back pressure in psi
⁷ Not determined

TABLE 6
Extrusion coating polymer properties

| Example | OS¹ rank | VOC² rank |
|---|---|---|
| Control | 1 | 2 |
| Comparative | 2 | 3 |
| Sample I | | |
| Inventive | 1 | 2 |
| Example I | | |

¹OS = oxygenated species (OS); VOC = total volatile organic compounds
²See WO2014/003837

As seen in Tables 3 and 5-6, Inventive Example I has excellent melt strength (MS), excellent thermal stability (low OS and VOC levels), and good extrusion coating properties. It is noted that Inventive Example I is more thermally stable during melt processing than Comparative Sample I and does not decompose into chemical species that produce a pungent odor during processing and could also impart bad taste and odor to foodstuff.

4. Polymerization II: Tubular Reactor

Comparative Sample A′ and Comparative Sample B′

The polymerization was carried out in a tubular reactor with three reaction zones. In each reaction zone, pressurized water was used for cooling and/or heating the reaction medium, by circulating this water through the jacket of the reactor. The inlet-pressure was 222 MPa, and the pressure drop over the whole tubular reactor system was about 30 MPa. Each reaction zone had one inlet and one outlet. Each inlet stream consisted of the outlet stream from the previous reaction zone and/or an added ethylene-rich feed stream. The non-converted ethylene, and other gaseous components in the reactor outlet, were recycled through a high pressure recycle and a low pressure recycle, and were compressed and distributed through a booster, a primary and a hyper (secondary) compressors. Organic peroxides (tert-Butyl peroxy-2-ethyl hexanoate and Di-tert-butyl peroxide) were fed into each reaction zone. Propionaldehyde (PA) was used as a chain transfer agent (CTA), and it was present in each reaction zone inlet, originating from the low pressure and high pressure recycle flows. The fresh PA was added only to the second and third reactions zones in the ratio equivalent to 0.8 and 0.2 respectively. Fresh ethylene was directed towards the first reaction zone.

After reaching the first peak temperature (maximum temperature) in reaction zone 1, the reaction medium was cooled with the aid of the pressurized water. At the outlet of reaction zone 1, the reaction medium was further cooled by injecting cold, ethylene-rich feed and the reaction was re-initiated by feeding an organic peroxide system. This process was repeated at the end of the second reaction zone to enable further polymerization in the third reaction zone. The polymer was extruded and pelletized (about 30 pellets per gram), using a single screw extruder at a melt temperature around 230-250° C. The weight ratio of the ethylene-rich feed streams to the three reaction zones was 1.00:0.80:0.20. The internal process velocity was approximately 12.5, 9 and 11 m/sec for respectively the first, second, and third reaction zone. Additional information can be found in Tables 7-10 below.

### Inventive Example 1′

The polymerization was carried out in a tubular reactor with three reaction zones, as discussed above for Comparative Sample A′. All process conditions are the same as for Comparative Sample A′, except for inventive example 1′, Additive A was added to the first zone. The amount can be found in Table 8. Additional information can be found in Tables 7 and 9.

### Inventive Example 2′

The polymerization was carried out in a tubular reactor with three reaction zones, as discussed above for Inventive Example 1′. All process conditions are the same as for Inventive Example 1′, except additional Additive A was fed to the first zone. Additional information can be found in Tables 7-9 below.

### Inventive Example 3′

The polymerization was carried out in a tubular reactor with three reaction zones, as discussed above for Inventive Example 1′. All process conditions are the same as for Inventive Example 1′, except additional Additive A was fed to the first zone and additional propionaldehyde (PA) was fed to adjust the melt index of the material. Additional information can be found in Tables 7-9 below.

TABLE 7
Pressure and temperature conditions of comparative and inventive examples

| | Inlet- | Start- | reinitiation | reinitiation | | | |
|---|---|---|---|---|---|---|---|
| | pressure, | temp., | temp. | temp. | 1st Peak | 2nd Peak | 3rd Peak |
| | Mpa | ° C. | 2nd zone, ° C. | 3rd zone, ° C. | temp., ° C. | temp.,° C. | temp. ° C. |
| CS A′ | 222.5 | 145 | 145 | 227 | 295 | 294 | 292 |
| CS B′ | 222 | 145 | 145 | 222 | 295 | 294 | 294 |
| IE 1′ | 222.5 | 145 | 145 | 227 | 295 | 294 | 293 |
| IE 2′ | 222 | 145 | 145 | 229 | 295 | 293 | 293 |
| IE 3′ | 222 | 145 | 145 | 222 | 295 | 294 | 294 |

TABLE 8
Additional information of the comparative and inventive examples

| | Additive A | | | |
|---|---|---|---|---|
| | flow/kg h⁻¹ | MI (I₂) | | Melt Elasticity |
| | (1^{st} zone) | g/10 min | Conversion % | cN |
| CS A′ | 0 | 3.9 | 37.7 | 2.6 |
| CS B′ | 0 | 7.0 | 38.1 | 1.3 |
| IE 1′ | 25 | 3.8 | 38.0 | 3.5 |
| IE 2′ | 36 | 3.7 | 38.2 | 4.1 |
| IE 3′ | 36 | 6.8 | 38.5 | 2.4 |

TABLE 9
Polymer properties of the examples

| | | | | | GI-200 | | | | |
|---|---|---|---|---|---|---|---|---|---|
| | | | A + B(I₂)* | Is Mw | unit = mm² | G′ (at | C + | Is G′ | |
| | MI (I₂) | | units = | (abs) less | gel per | 170° C.; | Dlog(I₂)** | greater | |
| | g/10 | Mw (abs) | g/mol | than Eq. A | 24.6 cm³ | G″ = 500 Pa) | unit = Pa | than Eq. B | Density |
| | min | g/mol | (Eq. 1) | value? | of film | unit = Pa | (Eq. B) | value? | g/cm³ |
| PG7004 | 4.1 | >300000 | 232200 | No | N.D. | 146 | 130 | yes | 0.9215 |
| | | | | (fail) | | | | (pass) | |
| PT7007 | 7.5 | 355000 | 205000 | No | N.D. | 129 | 106 | yes | 0.9174 |
| | | | | (fail) | | | | (pass) | |
| PT7009 | 8.7 | 346000 | 195400 | No | N.D. | 120 | 100 | yes | 0.9188 |
| | | | | (fail) | | | | (pass) | |
| A′ | 3.9 | 193,145 | 234200 | Yes | 0.37 | 124 | 132 | no | 0.9238 |
| | | | | (pass) | | | | (fail) | |
| B′ | 7.0 | 167,809 | 235080 | Yes | 0.19 | 102 | 109 | no | 0.9241 |
| | | | | (pass) | | | | (fail) | |
| IE 1′ | 3.8 | 211,580 | 236440 | Yes | 0.1 | 146 | 133 | yes | 0.9232 |
| | | | | (pass) | | | | (pass) | |
| IE 2′ | 3.7 | 232,324 | 235800 | Yes | 0.6 | 160 | 134 | yes | 0.9230 |
| | | | | (pass) | | | | (pass) | |
| IE ′ | 6.8 | 203,214 | 234520 | Yes | 0.4 | 117 | 110 | yes | 0.9231 |
| | | | | (pass) | | | | (pass) | |

*A = 2.65 × 10⁵ g/mole, and B = −8.00 × 10³ (g/mole)/(dg/min)
**C = 185 Pa and D = −90 Pa/log(dg/min)

As shown in Table 9, comparative samples (CS) PG7004, PT7007, PT7009 have higher Mw(abs) compared to each respective Equation A value thereby indicating that comparative samples PG7004, PT7007, PT7009 are produced in an autoclave configuration. Comparative samples A′, B′ and inventive examples 1′, 2′ and 3′ each have an Mw(abs) value less than the Equation A value denoting polymerization in a tubular reactor configuration. PG7004, PT7007, PT7009 and inventive examples (1E) 1′, 2′, 3′ each have a higher G′ value than respective value calculated from Equation B (“pass” Equation B) indicating greater longer chain branching than would be possible in a tubular reactor under the same temperature/pressure reactor conditions and without an additive, as indicated by comparative samples A′, B′ (no additive), A′, B′ failing the G′ requirement (“fail” for Equation B) set forth in Equation B. Inventive examples 1′, 2′, 3′ unexpectedly exhibit the combination of enhanced branching (i.e., passing Equation B) and production in a tubular reactor (i.e., passing Equation A) thereby providing a branched polymer in a low energy efficient production process.

The Inventive Examples exhibit enhanced branching with addition of the additive (Additive A) in multiple reactor types. The enhanced branching resulted in materials with superior melt elasticity and melt strength, which is advantageous in a variety of polymer applications including extrusion coating. In particular, the use of the additives in a tubular reactor enables melt strength in the Inventive Examples compared to materials produced in an autoclave reactor. The resultant ethylene-based polymer composition also had improved (reduced) taste and odor performance, as compared to other polymer compositions modified with other types of branching agents.

It is specifically intended that the present disclosure not be limited to the embodiments and illustrations contained herein, but include modified forms of those embodiments including portions of the embodiments and combinations of elements of different embodiments as come within the scope of the following claims.

1. An ethylene-based polymer composition formed by high pressure (greater than or equal to 100 MPa), free-radical polymerization, by reacting: ethylene monomer and a mixture of hydrocarbon-based molecules, each hydrocarbon-based molecule comprising three or more terminal alkene groups.

2. The ethylene-based polymer composition of claim 1, wherein the hydrocarbon-based molecules have the Structure I: 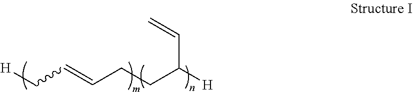
wherein n is from 3 to 160, and m is from 0 to 50.

3. The ethylene-based polymer composition of claim 2, wherein the mixture of hydrocarbon-based molecules based on Structure I has a molecular weight distribution from 1.2 to 10.

4. The ethylene-based polymer composition of claim 1, wherein the hydrocarbon-based molecules have the Structure II: 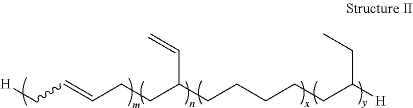
wherein n is from 3 to 160, and m is from 0 to 50; x is from 0 to 160, and y is from 0 to 50.

5. The ethylene-based polymer composition of claim 4, wherein the mixture of hydrocarbon-based molecules based on Structure II has a molecular weight distribution from 1.2 to 10.

6. The ethylene-based polymer composition of claim 1 5 wherein the ethylene-based polymer composition has a G′ value that meets the following relationship:
G′≥C+D log(I₂),
wherein C is 185 Pascal and D is −90 Pa/log(g/10 min), and
I₂ is the melt index of the ethylene-based polymer composition, measured in grams/10 minutes (g/10 min).

7. The ethylene-based polymer composition of claim 1, wherein the ethylene-based polymer composition comprises, in polymerized form, from 95 wt % to 99.98 wt % of ethylene, based on the total weight of the ethylene-based polymer composition.

8. The ethylene-based polymer composition of claim 1, wherein the ethylene-based polymer composition comprises, in polymerized form, from 0.02 wt % to 5.0 wt % of the mixture of hydrocarbon-based molecules, based on the total weight of the ethylene-based polymer composition.

9. The ethylene-based polymer composition of claim 1, wherein the ethylene-based polymer composition has a melt index (I₂) from 0.10 g/10 min to 200 g/10 min.

10. The ethylene-based polymer composition of claim 1, wherein the ethylene-based polymer composition has an alkenes content from 0.05/1000 carbons to 3.0/1000 carbons.

11. The ethylene-based polymer composition of claim 1, wherein the ethylene-based polymer composition has a GI200 value from 0 mm²/24.6 cm³ to 20 mm²/24.6 cm³.

12. The ethylene-based polymer composition of claim 1, wherein the ethylene-based polymer composition has a density from 0.909 g/cc to 0.940 g/cc.

13. The ethylene-based polymer composition of claim 1, wherein the ethylene-based polymer composition is a low density polyethylene comprising, in polymerized form, ethylene monomer and the mixture of hydrocarbon-based molecules.

14. The ethylene-based polymer composition of claim 1, further comprising a blend component, wherein the blend component does not include the mixture of hydrocarbon-based molecules.

15. An article comprising the composition of claim 1.

16. The article of claim 15, wherein the article is selected from the group consisting of a film, a coating, a coating for a cable, a coating for a wire, and a coated sheet.

17. A process comprising:
reacting, in a polymerization reactor under free-radical polymerization conditions and at a pressure greater than or equal to 100 MPa, ethylene monomer and a mixture of hydrocarbon-based molecules, each hydrocarbon-based molecule comprising three or more terminal alkene groups; and
forming an ethylene-based polymer composition.

18. The process of claim 17 comprising reacting ethylene monomer with a mixture of hydrocarbon-based molecules, each the hydrocarbon-based molecule having the Structure I: 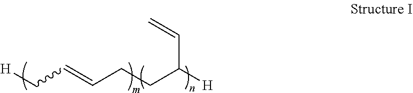
wherein n is from 3 to 160, and m is from 0 to 50; and
forming an ethylene-based polymer.

19. The process of claim 17, wherein the polymerization takes place in a reactor configuration comprising at least one tubular reactor.

20. The process of claim 17, wherein the polymerization takes place in a reactor configuration comprising at least one autoclave reactor.
